(19) United States
(12) Patent Application Publication
(10) Pub. No.: US 2025/0383651 A1
(43) Pub. Date: Dec. 18, 2025

(54) PROCESS MANAGEMENT SYSTEM AND OPERATING METHOD THEREOF

(71) Applicant: InnoLux Corporation, Miao-Li County (TW)

(72) Inventors: Meng-Xue WU, Miao-Li County (TW); Yung-Hua Chang, Miao-Li County (TW); Wen-Jie Tsai, Miao-Li County (TW); Tzu-Cheng Lee, Miao-Li County (TW)

(73) Assignee: InnoLux Corporation, Miao-Li County (TW)

(21) Appl. No.: 19/211,261

(22) Filed: May 18, 2025

(30) Foreign Application Priority Data
Jun. 17, 2024 (CN) 202410774300.9

(51) Int. Cl. G05B 19/418

(52) U.S. Cl. CPC G05B 19/41875; G05B 2219/32368

(57) ABSTRACT

A process management system is provided by the present disclosure. The process management system includes a receiving unit, a calculating unit, a comparing unit and an output unit. The receiving unit is used for receiving a real-time data of a machine, wherein the real-time data includes at least one parameter value. The calculating unit is used for calculating and generating at least one contribution value of the real-time data, wherein the at least one contribution value is calculated from the at least one parameter value. The comparing unit is used for comparing the at least one contribution value and at least one controlled contribution value of at least one controlled data to generate at least one comparing value. The output unit is used for outputting at least one comparing result to which the at least one comparing value corresponds.

### BACKGROUND OF THE DISCLOSURE

### 1. Field of the Disclosure

The present disclosure relates to a process management system, and more particularly to a fault detection classification (FDC) system.

### 2. Description of the Prior Art

Abnormalities in the current manufacturing processes can be detected through personnel inspection or sensors. However, when fault detection classification (FDC) is required, manual analysis is still required, which increases the difficulty of process control. Therefore, to improve the FDC system is still an important issue in the present field.

### SUMMARY OF THE DISCLOSURE

The present disclosure aims at providing a process management system.

A process management system is provided by the present disclosure, wherein the process management system includes a receiving unit, a calculating unit, a comparing unit and an output unit. The receiving unit is used for receiving a real-time data of a machine, wherein the real-time data includes at least one parameter value. The calculating unit is used for calculating and generating at least one contribution value of the real-time data, wherein the contribution value is calculated from the parameter value. The comparing unit is used for comparing the at least one contribution value and at least one controlled contribution value of at least one controlled data to generate at least one comparing value. The output unit is used for outputting at least one comparing result to which the at least one comparing value corresponds.

An operating method of a process management system is provided by the present disclosure. The operating method includes receiving a real-time data through a receiving unit of the process management system, wherein the real-time data comprises at least one parameter value; calculating at least one contribution value of the real-time data through a calculating unit of the process management system, wherein the at least one contribution value is calculated from the at least one parameter value; comparing the at least one contribution value and at least one controlled contribution value of at least one controlled data to generate at least one comparing value through a comparing unit of the process management system; and outputting at least one comparing result to which the at least one comparing value corresponds through an output unit of the process management system.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 shows a block diagram of a process management system of the present disclosure.

FIG. 2 shows a flow chart of the comparing process of abnormal events by the process management system of the present disclosure.

FIG. 3 shows a flow chart of processing the abnormal events by the process management system of the present disclosure.

FIG. 4 shows the contribution values of a real-time data and controlled contribution values of a controlled data according to an embodiment of the present disclosure.

FIG. 5 shows the contribution values of a real-time data and controlled contribution values of a controlled data according to another embodiment of the present disclosure.

FIG. 6 shows a schematic diagram of change of the health indicators of the process monitored by the process management system of the present disclosure over time.

FIG. 7 shows the comparing method of abnormal events of multiple samples under different monitoring models by the process management system of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, the manufacturers may refer to an element by different names. This document does not intend to distinguish between elements that differ in name but not function.

In the following description and in the claims, the terms “include”, “comprise” and “have” are used in an open-ended fashion, and thus should be interpreted to mean “include, but not limited to . . . ”.

It will be understood that when an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented. When an element or a layer is referred to as being “electrically connected” to another element or layer, it can be a direct electrical connection or an indirect electrical connection. The electrical connection or coupling described in the present disclosure may refer to a direct connection or an indirect connection. In the case of a direct connection, the ends of the elements on two circuits are directly connected or connected to each other by a conductor segment. In the case of an indirect connection, switches, diodes, capacitors, inductors, resistors, other suitable elements or combinations of the above elements may be included between the ends of the elements on two circuits, but not limited thereto.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

According to the present disclosure, the thickness, length and width may be measured through optical microscope, and the thickness or width may be measured through the cross-sectional view in the electron microscope, but not limited thereto.

In addition, any two values or directions used for comparison may have certain errors. In addition, the terms “equal to”, “equal”, “the same”, “approximately” or “substantially” are generally interpreted as being within ±20%, ±10%, ±5%, ±3%, ±2%, ±1%, or ±0.5% of the given value.

In addition, the terms “the given range is from a first value to a second value” or “the given range is located between a first value and a second value” represents that the given range includes the first value, the second value and other values there between.

If a first direction is said to be perpendicular to a second direction, the included angle between the first direction and the second direction may be located between 80 to 100 degrees. If a first direction is said to be parallel to a second direction, the included angle between the first direction and the second direction may be located between 0 to 10 degrees.

Unless it is additionally defined, all terms (including technical and scientific terms) used herein have the same meaning as commonly understood by those ordinary skilled in the art. It can be understood that these terms that are defined in commonly used dictionaries should be interpreted as having meanings consistent with the relevant art and the background or content of the present disclosure, and should not be interpreted in an idealized or overly formal manner, unless it is specifically defined in the embodiments of the present disclosure.

It should be noted that the technical features in different embodiments described in the following can be replaced, recombined, or mixed with one another to constitute another embodiment without departing from the spirit of the present disclosure.

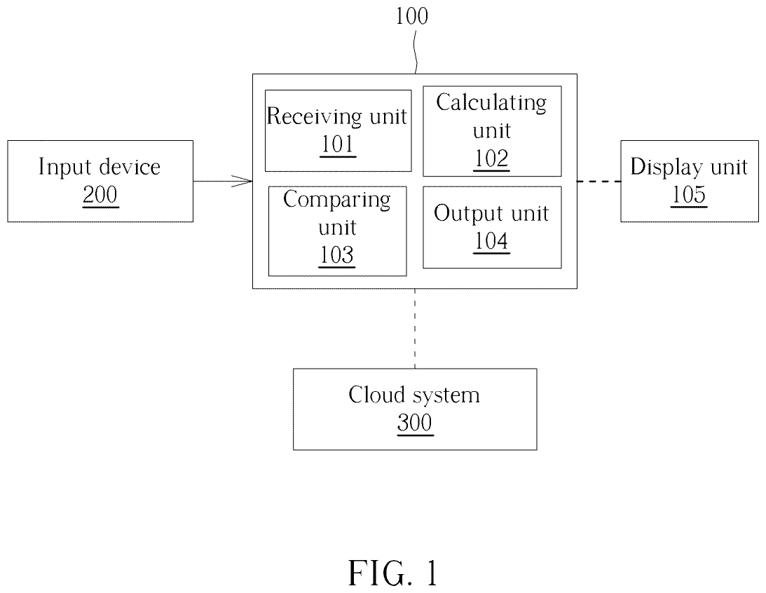

Referring to FIG. 1, FIG. 1 shows a block diagram of a process management system of the present disclosure. The process management system 100 of the present disclosure may monitor the process parameter(s) of manufacturing equipment (such as a machine) and may detect abnormal events of the machine or the product. The process management system 100 may for example include a fault detection classification (FDC) system, but not limited thereto. According to the present embodiment, as shown in FIG. 1, the process management system 100 may include a receiving unit 101, a calculating unit 102, a comparing unit 103 and an output unit 104, but not limited thereto. The receiving unit 101 may be used for receiving a real-time data of a machine monitored by the process management system 100. When the machine is in operation, a real-time data of the machine at any time may be captured (or collected) through the receiving unit 101. The “real-time data” described herein may include at least one process parameter, or the real-time data may consist of at least one process parameter. In other words, the receiving unit 101 may receive at least one process parameter of the machine at any time. Specifically, the process parameter(s) (that is, the real-time data) of the machine may be entered by an input device 200, and the real-time data may be received by the receiving unit 101. Each of the process parameter(s) in the real-time data may include a parameter value. Therefore, when the real-time data includes one process parameter, the real-time data may include a parameter value of the process parameter; and when the real-time data includes a plurality of process parameters, the real-time data may include a plurality of parameter values of the plurality of process parameters. The process parameter(s) included in the real-time data received by the receiving unit 101 may be determined according to the manufacturing process of the product (which can also be called as a sample in the following) or the monitoring requirements of the process management system 100. For example, in an embodiment, the sample manufactured by the machine may be glass, and the process parameters included in the real-time data may be the parameters related to the manufacturing process of glass, such as air flow rate, temperature, pressure, and the like, but not limited thereto. In the present embodiment, a real-time data may be the data monitored in the manufacturing process of a product (also called as a sample in the following). Specifically, during the manufacturing process of a sample, the process management system 100 may monitor the values of the process parameters (that is, the parameter values mentioned above) of the machine which serve as the real-time data received by the receiving unit 101. It should be noted that the process parameter(s) included in the real-time data may be a portion of the process parameters of the machine that can be monitored by the process management system 100. In other words, the real-time data is not limited to include all the process parameters of the machine that can be monitored by the process management system 100. Specifically, the number or types of the process parameters included in the real-time data may be determined according to the monitoring requirements for the process parameters.

The calculating unit 102 may be used for calculating and generating at least one contribution value of the real-time data, wherein the contribution value of the real-time data is calculated from the parameter value of the process parameter of the real-time data. Specifically, after the real-time data is received by the receiving unit 101, the real-time data may be transmitted to the calculating unit 102 to calculate the contribution value of the real-time data. According to the present disclosure, the parameter value of a process parameter in the real-time data may be converted into a contribution value of the real-time data by the calculating unit 102. In other words, a contribution value of a real-time data may serve as the contribution value of a process parameter in the real-time data. In such condition, the parameter values of N process parameters in the real-time data may be converted into N contribution values, that is, the number of the parameter values in a real-time data may be the same as the number of the contribution values in the real-time data. The calculating method of the contribution values will be detailed in the following.

The comparing unit 103 may be used for comparing the at least one contribution value of the real-time data and at least one controlled contribution value of at least one controlled data to generate at least one comparing value. Specifically, after the contribution value(s) of a real-time data is calculated by the calculating unit 102, the contribution value(s) of the real-time data may be transmitted to the comparing unit 103 and compared with the controlled contribution value of the controlled data. According to the present disclosure, the controlled data may be the portion of the data received by the receiving unit 101 (that is, the real-time data) that is determined to be controlled. For example, the controlled data may include abnormal data, but not limited thereto. The “abnormal data” described herein may be the real-time data received when the process parameters deviate from the normal range or sample abnormalities occur. In other words, when the process management system 100 monitors that the process parameters deviate from the normal range during the manufacturing process of a sample, or the sample is determined to be abnormal in subsequent testing, the real-time data monitored during the manufacturing process of the sample may be regarded as the controlled data. That is, the controlled data (or the controlled contribution value of the controlled data) may be obtained when the machine is failed and/or abnormal. Specifically, in an embodiment, the process management system 100 may include a controlled database, wherein the controlled database may include at least one controlled data. The controlled database may be created by collecting controlled data and may for example be stored in the comparing unit 103, but not limited thereto. The controlled database may also be stored in other units or systems, such as a cloud system 300, but not limited thereto. After the contribution value of a real-time data is calculated by the calculating unit 102, the contribution value of the real-time data may be compared with the controlled contribution value of each of the controlled data in the controlled database by the comparing unit 103, wherein a comparing value may be generated after the contribution value of the real-time data is compared with the controlled contribution value of a controlled data. In other words, N comparing values may be generated after comparing the contribution values of the real-time data and the controlled contribution values of N controlled data in the controlled database. The comparing method of the contribution value of the real-time data and the controlled contribution value of the controlled data (or the method of generating the comparing values) will be detailed in the following. Similarly, the controlled data may include at least one process parameter, wherein each of the process parameters of the controlled data may include a parameter value. The calculating method of the controlled contribution value of the controlled data may be the same as the calculating method of the contribution value of the real-time data, which will be detailed in the following.

The output unit 104 may be used for outputting the comparing result to which the comparing value corresponds. Specifically, after a comparing value is generated after the contribution value of the real-time data and the controlled contribution value of a controlled data are compared through the comparing unit 103, the output unit 104 may output the comparing result to which the comparing value corresponds, “A comparing result to which a comparing value corresponds” described herein may be the comparing result of the controlled data that generates the comparing value. That is, when the comparing unit 103 compares the contribution value of the real-time data with the controlled contribution value of a controlled data to generate a comparing value, the comparing result to which the comparing value corresponds may be the comparing result of the controlled data. In the present disclosure, the comparing result of a controlled data may include the cause and/or the solution of the controlled data. It should be noted that the output unit 104 may not output the comparing results corresponding to all comparing values, but only output the comparing results corresponding to certain comparing values, and the details thereof will be described in the following.

As shown in FIG. 1, in some embodiments, the real-time data monitored by the process management system 100 may also be stored in a cloud system 300, which facilitates the user's subsequent tracing of the real-time data. For example, the user may more easily trace the process parameters of the machine during the manufacturing process of a completed sample.

The operating method of the process management system 100 of the present disclosure will be detailed in the following.

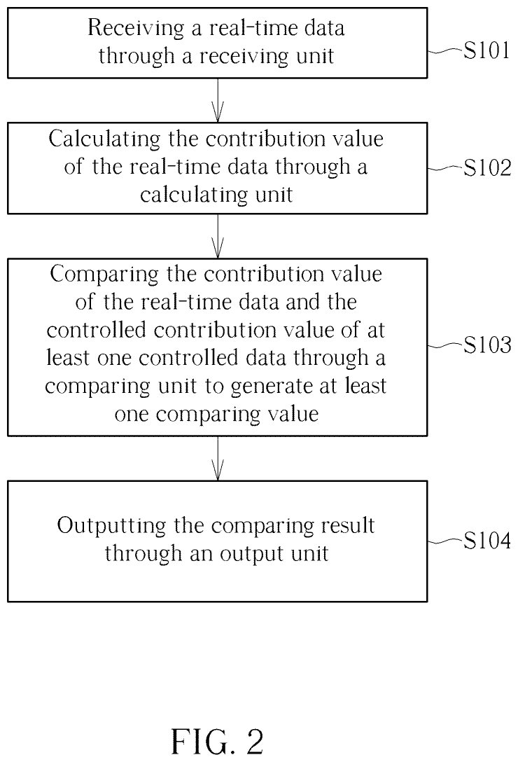

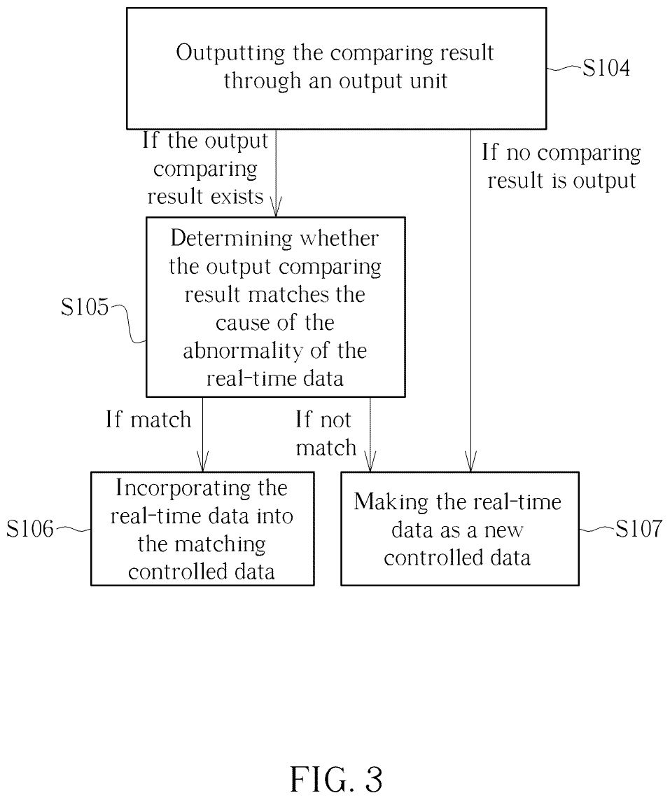

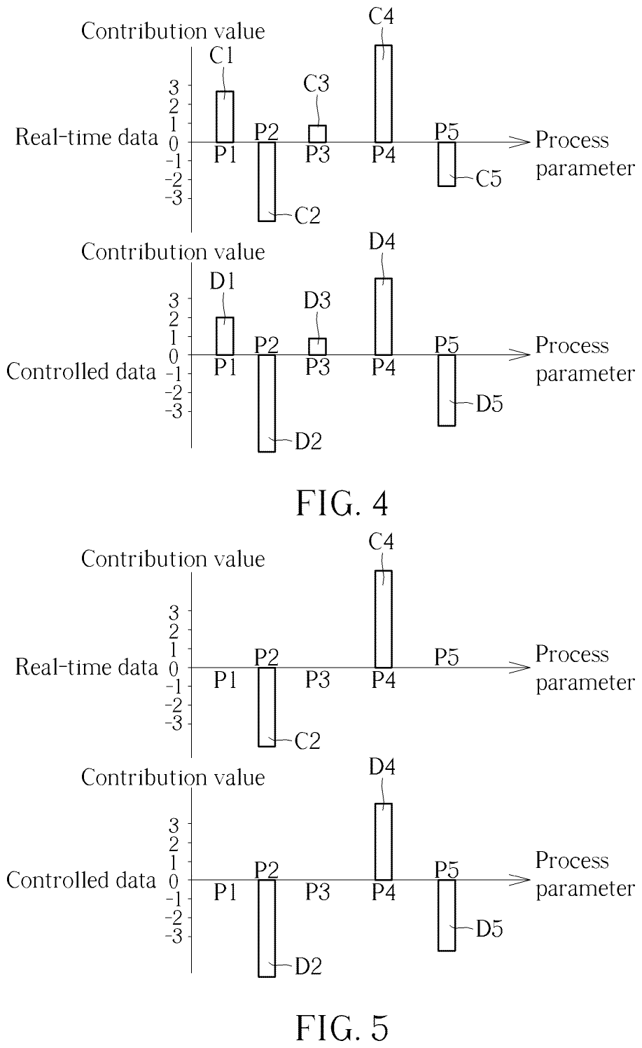

Referring to FIG. 2 to FIG. 5, FIG. 2 shows a flow chart of the comparing process of abnormal events by the process management system of the present disclosure, FIG. 3 shows a flow chart of processing the abnormal events by the process management system of the present disclosure, FIG. 4 shows the contribution values of a real-time data and controlled contribution values of a controlled data according to an embodiment of the present disclosure, and FIG. 5 shows the contribution values of a real-time data and controlled contribution values of a controlled data according to another embodiment of the present disclosure. As shown in FIG. 2, the operating method of the process management system 100 of the present disclosure may include the following steps:
S101: receiving a real-time data through a receiving unit;
S102: calculating the contribution value of the real-time data through a calculating unit;
S103: comparing the contribution value of the real-time data and the controlled contribution value of at least one controlled data through a comparing unit to generate at least one comparing value;
S104: outputting the comparing result through an output unit.

The operating method of the process management system 100 may include the step S101: receiving a real-time data through the receiving unit 101 at first. Specifically, the value of at least one process parameter of the machine during the manufacturing process of a sample may be transmitted to the receiving unit 101 as a real-time data. According to the present disclosure, the real-time data of the machine may be received by the receiving unit 101 when a controlled alarm is triggered. Specifically, the values of the process parameters of the machine during the manufacturing process of each sample may be measured, but only the process parameters of the samples that trigger the controlled alarm (or the real-time data of the samples that trigger the controlled alarm) are transmitted to the receiving unit 101 to perform the subsequent management process. The controlled alarm may be triggered when the machine is abnormal and/or the sample manufactured by the machine is abnormal, but not limited thereto. In other words, the controlled alarm may be triggered when abnormal events occur on the machine and/or the sample. In some embodiments, when a process parameter of the machine measured in the manufacturing process of a sample deviates from the normal range (regarded as an abnormal event), the process management system 100 may trigger a controlled alarm itself, and the value of the process parameter may be transmitted to the receiving unit 101 as a real-time data. In some embodiments, when the quality of a sample is detected to be abnormal in subsequent testing steps (regarded as an abnormal event), the user may trigger the controlled alarm of the sample and make a further confirmation of the sample. In such condition, the values of the process parameters measured during the manufacturing process of the sample may be traced and may be regarded as the “real-time data” mentioned above. In some embodiments, when any one of the abnormal events mentioned above occurs, the controlled alarm may be triggered. In some embodiments, the controlled alarm may be triggered due to other abnormal events, which is not limited to the conditions mentioned above. It should be noted that “the process parameter of the real-time data” mentioned above may be certain process parameters selected according to monitoring requirements among all process parameters that can be monitored by the process management system 100, rather than all process parameters that can be monitored by the process management system 100. The definition of the “process parameter of the real-time data” described in the present disclosure may refer to the contents above, and will not be redundantly described in the following.

After the real-time data is received by the receiving unit 101, the step S102: calculating the contribution value of the real-time data through the calculating unit 102 may be performed. According to the present disclosure, the contribution value of the real-time data may be calculated according to a default data string. The default data string may consist of the process parameter(s) measured in the manufacturing process of at least one health sample. The “health sample” described herein may be the sample that is not detected to be abnormal in subsequent testing. Specifically, the default data string may include a plurality of default data, wherein each of the default data may include the parameter value (which can be called as the default parameter value) of at least one process parameter measured in the manufacturing process of a health sample. For example, the default data string may consist of the default parameter values of the at least one process parameter (that is, the default data) respectively measured in the manufacturing processes of N health samples, and the default data string may include N default data in this case, wherein each of the default data may include at least one process parameter. In such condition, in the default data string, a process parameter may have multiple parameter values from different default data. Therefore, the average value and the standard deviation of each of the process parameters of the default data string may be calculated. For example, in an embodiment, the default data string may consist of the default data of N health samples (which are called as the health sample S1 to the health sample Sn in the following), and each of the default data may include a parameter value of a process parameter P1 (for example, temperature), a parameter value of a process parameter P2 (for example, pressure) and a parameter value of a process parameter P3 (for example, air flow rate), but not limited thereto. In such condition, the average value and standard deviation of the temperatures in the default data string may be calculated from the values of the temperatures of the healthy samples S1-Sn. Similarly, the average value and standard deviation of the pressures and the average value and standard deviation of the air flow rates may be calculated in the same way.

The receiving unit 101 may calculate the contribution value of the real-time data received by the above-mentioned receiving unit 101 according to the average values and the standard deviations of the process parameters of the default data string. The parameter value of each of the process parameters of the real-time data may be converted into a contribution value. Specifically, the real-time data includes a parameter value Vn of a process parameter Pn, the real-time data includes a contribution value Cn calculated from the parameter value Vn, a plurality of the default parameter values of the plurality of default data of the above-mentioned default data string corresponding to the parameter value Vn has an average value An and a standard deviation Sn, and the contribution value Cn may be calculated through the following formula (1):

$$Cn = ( Vn - An ) / Sn \qquad ( 1 )$$

“The plurality of the default parameter values of the plurality of default data of the default data string corresponding to the parameter value Vn” mentioned above may be the plurality of default parameter values of the default data which are the values of the same process parameter as the parameter value Vn. For example, the values of the temperature of the plurality of default data of the default data string may be regarded to be corresponding to the value of the temperature of the real-time data. For example, in an embodiment, the real-time data may include a value (the parameter value) of temperature (process parameter) of 500° C., and the average value and the standard deviation of the temperatures of a plurality of health samples of the default data string are respectively 800° C. and 150° C., and in such condition, the contribution value of temperature of the real-time data may be calculated to be −2. The contribution value of other process parameters of the real-time data may be calculated in the same way, and will not be redundantly described. According to the formula (1) mentioned above, the contribution value of a process parameter of the real-time data may represent the degree to which the process parameter deviates from the average value of the process parameter in the default data string. Specifically, when the contribution value of a process parameter of the real-time data is further away from 0, the process parameter is more deviated from the normal state of the process parameter of the default data string. The average value and standard deviation of each process parameter of the default data string may be used to represent the normal range of the each process parameter. Therefore, the contribution values of the real-time data may be used to represent the degree of deviation of the process parameters of the real-time data from the normal range.

In some embodiments, the contribution value of the real-time data may be calculated through other ways. Specifically, the real-time data includes a parameter value Vn of a process parameter Pn, the real-time data includes a contribution value Cn calculated from the parameter value Vn, a plurality of the default parameter values of the plurality of default data of the above-mentioned default data string corresponding to the parameter value Vn has an average value An, and the contribution value Cn may be calculated through the following formula (2):

$$Cn = Vn - An \qquad ( 2 )$$

In other words, the contribution value of a process parameter of the real-time data may be the parameter value of the process parameter minus the average value of all parameter values of the process parameter of the plurality of default data of the default data string. For example, in an embodiment, the real-time data may include a value (the parameter value) of temperature (process parameter) of 500° C., and the average value of the temperatures of a plurality of health samples of the default data string is 800° C., and in such condition, the contribution value of temperature of the real-time data may be calculated to be −300.

It should be noted that the calculating methods of the contribution value of the real-time data mentioned above are exemplary, and it is not limited in the present disclosure. The contribution value may be calculated through different ways according to actual requirements or settings.

After the contribution value of the real-time data is calculated, the step S103: comparing the contribution value of the real-time data and the controlled contribution value of at least one controlled data through the comparing unit 103 to generate at least one comparing value may be performed. Specifically, after the contribution value of the real-time data is generated by the calculating unit 102 (the parameter value of each process parameter of the real-time data may be converted into a contribution value), the contribution value of the real-time data may be compared with the controlled contribution value of at least one controlled data in the controlled database to generate at least one comparing value. As mentioned above, the calculating method of the controlled contribution value of the controlled data may be the same as the calculating method of the contribution value of the real-time data. That is, at least one controlled contribution value of the controlled data may also be calculated according to the default data string. In other words, the contribution value of the controlled data and the contribution value of the real-time data are calculated based on the same formula (for example, the formula (1) or the formula (2) mentioned above). In detail, after the process management system 100 receives a controlled data, the controlled contribution value of the controlled data may be calculated through the above-mentioned formula (1) or formula (2) and stored in the controlled database. After that, when the receiving unit 101 receives a real-time data, the contribution value of the real-time data may be calculated by the calculating unit 102 at first, and then the contribution value of the real-time data may be compared with the controlled contribution value of the controlled data stored in the controlled database.

According to the present disclosure, the comparing unit 103 may compare the contribution value of the real-time data with the controlled contribution values of each controlled data in the controlled database, and the contribution value of the real-time data and the contribution value of each controlled data may respectively generate a comparing value after comparison. Specifically, a real-time data may include a contribution value Cn of a process parameter Pn, a controlled data may include a controlled contribution value Dn of the process parameter Pn, and after comparing the contribution value Cn of the process parameter Pn of the real-time data with the controlled contribution value Dn of the process parameter Pn of the controlled data, a sub-comparing value En may be obtained according the following formula (3):

$$En = \vert ( Cn - Dn ) / Dn \vert \qquad ( 3 )$$

In other words, the contribution value of a process parameter of the real-time data and the contribution value of the process parameter of the controlled data may generate a sub-comparing value. In such condition, when the real-time data includes a plurality of process parameters, the contribution values of the plurality of process parameters may be compared with the controlled contribution values of a controlled data to generate a plurality of sub-comparing value. According to the present disclosure, the comparing value generated after comparing the contribution value of a real-time data with the controlled contribution value of a controlled data may be the average of at least one sub-comparing value generated after comparing the contribution value of at least one process parameter of the real-time data with the controlled contribution value of the controlled data. The generating method of the comparing value will be described in the following by taking the data shown in FIG. 4 as an example. As shown in FIG. 4, a real-time data may include a process parameter P1, a process parameter P2, a process parameter P3, a process parameter P4 and a process parameter P5 respectively has a contribution value C1, a contribution value C2, a contribution value C3, a contribution value C4 and a contribution value C5, and a controlled data may include the process parameter P1, the process parameter P2, the process parameter P3, the process parameter P4 and the process parameter P5 respectively has a controlled contribution value D1, a controlled contribution value D2, a controlled contribution value D3, a controlled contribution value D4 and a controlled contribution value D5. In such condition, after comparing the contribution value C1 of the process parameter P1 of the real-time data and the controlled contribution value D1 of the process parameter P1 of the controlled data, a sub-comparing value E1=|(C1−D1)/D1| may be generated. Similarly, after comparing the contribution value C2 of the process parameter P2 of the real-time data and the controlled contribution value D2 of the process parameter P2 of the controlled data, a sub-comparing value E2=|(C2−D2)/D2| may be generated; after comparing the contribution value C3 of the process parameter P3 of the real-time data and the controlled contribution value D3 of the process parameter P3 of the controlled data, a sub-comparing value E3=|(C3−D3)/D3| may be generated; after comparing the contribution value C4 of the process parameter P4 of the real-time data and the controlled contribution value D4 of the process parameter P4 of the controlled data, a sub-comparing value E4=|(C4−D4)/D4| may be generated; after comparing the contribution value C5 of the process parameter P5 of the real-time data and the controlled contribution value D5 of the process parameter P5 of the controlled data, a sub-comparing value E5=|(C5−D5)/D5| may be generated. In such condition, the comparing value generated after comparing the contribution values of the real-time data with the controlled contribution values of the controlled data shown in FIG. 4 may be the average of the sub-comparing value E1, the sub-comparing value E2, the sub-comparing value E3, the sub-comparing value E4 and the sub-comparing value E5. It should be noted that FIG. 4 just shows the controlled contribution values of a controlled data, the controlled database may include a plurality of controlled data, and the real-time data shown in FIG. 4 may be compared one by one with other controlled data in the controlled database according to the above-mentioned method and generate a comparing value respectively. In addition, the contribution values and the controlled contribution values shown in FIG. 4 and FIG. 5 are calculated from the formula (1) mentioned above, but it is not limited in the present disclosure.

According to the present disclosure, when comparing the contribution values of the real-time data with the controlled contribution values of the controlled data, it is not necessary to compare the process parameter with a controlled contribution value of 0 in the controlled data. For example, taking FIG. 5 as an example, when the controlled contribution value of the process parameter P1 and the controlled contribution value of the process parameter P3 of the controlled data are 0, the process parameter P1 and the process parameter P3 may be skipped when comparing the contribution value of the real-time data with the controlled contribution value of the controlled data. In other words, the controlled contribution value Dn shown in the formula (3) above will not be 0.

According to the present disclosure, when the comparing value generated after comparing the contribution value of the real-time data with the controlled contribution value of a controlled data is smaller, the matching degree between the contribution value of the real-time data and the controlled contribution value of the controlled data is greater. For example, when the comparing value generated after comparing the contribution value of the real-time data with the controlled contribution value of a controlled data is 0, the contribution value of the real-time data may completely match the controlled contribution value of the controlled data. “The matching degree between the contribution value of the real-time data and the controlled contribution value of the controlled data” mentioned above may refer to the degree of similarity between the contribution values of each process parameter of the real-time data and the controlled contribution values of each process parameter of the controlled data.

In some embodiments, after the contribution values of the real-time data are calculated, a filtering step may further be performed on the contribution values of the real-time data at first, and then the comparing step mentioned above is performed through the comparing unit 103. Specifically, as shown in FIG. 5, FIG. 5 shows the result of the contribution value of the real-time data shown in FIG. 4 after the filtering process. In the present embodiment, after the contribution value of the real-time data is calculated from the formula (1) mentioned above, the portion of at least one contribution value of the real-time data located in a range from −3 to 3 may be changed to 0, but not limited thereto. In detail, after a contribution value of a process parameter of the real-time data is calculated, if the contribution value is located in a range from −3 to 3, changes the contribution value to 0; and if the contribution value is less than −3 or greater than 3, the original calculated value is retained. For example, as shown in FIG. 4 and FIG. 5, after the contribution values of the real-time data are calculated, since the contribution values of the process parameter P1, the process parameter P3 and the process parameter P5 are located in a range from −3 to 3, the contribution values of the process parameter P1, the process parameter P3 and the process parameter P5 are changed to be 0. In some embodiments, the above-mentioned filtering step of the contribution value may include changing the portion of at least one contribution value of the real-time data located in a range from −2 to 2 to 0. In some embodiments, the range of contribution value changed to 0 in the filtering step may be determined according to the monitoring requirements of the process management system 100. Similarly, after the controlled data is collected, and the controlled contribution values of the controlled data are calculated, the filtering step may be performed on the controlled contribution values in the above-mentioned way. For example, referring to FIG. 4 and FIG. 5, after the contribution values of the controlled data are calculated, since the controlled contribution values of the process parameter P1 and the process parameter P3 are located in a range from −3 to 3, the controlled contribution values of the process parameter P1 and the process parameter P3 may be changed to 0. In such condition, as shown in FIG. 5, since the controlled contribution values of the process parameter P1 and the process parameter P3 are changed to 0 after the filtering step, the process parameter P1 and the process parameter P3 may be skipped when comparing the contribution values of the real-time data with the controlled contribution values of the controlled data. Therefore, time of the comparing step may be shortened, such that the abnormality of the process may be known as early as possible and the abnormality may be quickly eliminated, thereby improving the yield of the process and/or reducing the losses caused by the abnormality of the process, but not limited thereto. Therefore, the comparing value obtained according to the contribution values of the real-time data and the controlled contribution values of the controlled data shown in FIG. 5 may be the average of the sub-comparing value E2, the sub-comparing value E4 and the sub-comparing value E5. It should be noted that if the contribution values and the controlled contribution values are calculated from the formula (2) above, the filtering step mentioned above is not needed.

In some embodiments, after the real-time data is received by the receiving unit 101, the comparing unit 103 may directly compare the real-time data and the controlled data to obtain the comparing value. In other words, the step of calculating the contribution values of the real-time data (that is, the step S102) may be omitted. In such condition, the parameter value of at least one process parameter of the controlled data may also not be converted into the controlled contribution value. Specifically, a process parameter Pn of the real-time data may have a parameter value Vn, and the process parameter Pn of the controlled data may have a parameter value Bn, and the sub-comparing value En obtained by comparing the process parameter Pn of the real-time data and the process parameter Pn of the controlled data may be calculated from the following formula (4):

$$En = \vert ( Vn - Bn ) / Bn \vert \qquad ( 4 )$$

For example, in an embodiment, the real-time data may include a temperature of 500° C., and the controlled data may include a temperature of 800° C., and the sub-comparing value obtained after comparing the temperature of the real-time data and the temperature of the controlled data may be 0.375. Therefore, after the sub-comparing values obtained by comparing other process parameters of the real-time data (if any) and corresponding process parameters of the controlled data are calculated, the comparing value generated by comparing the real-time data and the controlled data may be the average of the sub-comparing values.

It should be noted that the comparing method (or generating method of the comparing value) of the real-time data and the controlled data mentioned above are exemplary, it is not limited in the present disclosure.

After the contribution value of the real-time data and the contribution value of the controlled data are compared through the comparing unit 103, the step S104: outputting the comparing result through the output unit 104 may be performed. Specifically, in the present embodiment, the output unit 104 may for example output the comparing results corresponding to the portion of the comparing values less than 1, that is, the output unit 104 just output a portion of the comparing results. As mentioned above, when the comparing value generated after comparing the contribution value of the real-time data with the controlled contribution value of a controlled data is smaller, the matching degree between the contribution value of the real-time data and the controlled contribution value of the controlled data is greater. Specifically, after the comparing unit 103 compares the contribution value of the real-time data with the controlled contribution value of at least one controlled data in the controlled database to generate at least one comparing value, the output unit 104 may output the comparing result recorded in the controlled data that generates the comparing value less than a certain value (for example, 1) (or the controlled data whose controlled contribution values match the contribution values of the real-time data to a higher degree), but not limited thereto. In some embodiments, the output unit 104 may output the comparing result recorded in the controlled data that generates the comparing value less than 0.5, 0.8 or other values. In some embodiments, among the controlled data that generates the comparing values less than 1, the output unit 104 may output the comparing result recorded in the portion of the controlled data that generates the minimum comparing value. The comparing result recorded in the controlled data may for example include the cause and/or solution of the controlled data, but not limited thereto. The comparing result recorded in the controlled data may further include other related information of the controlled data. In the present embodiment, the process management system 100 may further be coupled to a display unit 105, and after a comparing result is obtained, the display unit 105 may display the comparing result.

In summary, according to the present embodiment, when a controlled alarm is triggered due to abnormal events such as abnormality of the machine or abnormality of the sample, the receiving unit 101 may receive the real-time data under the abnormal event, and the calculating unit 102 may calculate the contribution values of each process parameter of the real-time data. After that, the comparing unit 103 may compare the contribution value of the real-time data and the controlled contribution value of the controlled data (for example, including abnormal data) in the controlled database, the controlled data that has a higher degree of matching with the real-time data may be selected through the design of comparing value, and the output unit 104 may output the comparing result recorded in the selected controlled data. Therefore, the process management system 100 may provide the user with abnormal causes and/or solutions of previously collected controlled data that is similar to the real-time data, thereby assisting the user in determining the abnormal causes of the real-time data. In addition, in some embodiments, through the above-mentioned filtering step of the contribution values of the real-time data and the controlled contribution values of the controlled data, the comparing step of the contribution value of the real-time data and the controlled contribution value of the controlled data may be further simplified or the comparing time of the comparing unit 103 may be reduced, thereby improving the performance of the process management system 100. Therefore, compared with current failure detection and classification systems, the process management system 100 of the present disclosure may improve the efficiency of handling abnormal events, thereby reducing losses caused by machine or sample abnormalities.

It should be noted that the comparing method mentioned above is exemplary, and it is not limited in the present disclosure.

According to the present disclosure, after the comparing result is outputted by the output unit 104, the real-time data may further be incorporated into the controlled database. Specifically, the real-time data may also be stored in the controlled database and serve as a controlled data. In some embodiments, the real-time data may be incorporated into the controlled database in terms of the cause of the abnormality. In detail, as shown in FIG. 3, in the step of outputting the comparing result corresponding to the portion of the comparing value less than 1 (or having other preset conditions) through the output unit 104 (that is, the step S104), it can be determined whether there is an comparing result output. If the output unit 104 outputs at least one comparing result, a step S105: determining whether the output comparing result matches the cause of the abnormality of the real-time data may be performed. In some embodiments, after the output unit 104 outputs at least one comparing result (which is stored in the controlled data that generates the comparing value less than 1), the user may confirm whether the causes and/or solutions of the abnormalities recorded in the controlled data are the cause and/or solutions of the abnormality of the real-time data received this time one by one, thereby confirming whether the controlled data matches the real-time data. In some embodiments, the controlled data that generates the minimum comparing value may be considered to match the real-time data. If the causes and/or solutions of the abnormality recorded in a controlled data is confirmed to be the causes and/or solutions of the abnormality of the real-time data, a step S106: incorporating the real-time data into the matching controlled data may be performed. Specifically, after the causes and/or solutions of the abnormality recorded in a controlled data is confirmed to be the causes and/or solutions of the abnormality of the real-time data, a record of the real-time data may be added in the controlled data, and the contribution value of the real-time data may be incorporated into the controlled contribution value of the controlled data. In detail, the contribution value of each process parameter of the real-time data may respectively be averaged with the controlled contribution value of each process parameter of the controlled data as new controlled contribution values of the controlled data. According to the storage method of the real-time data mentioned above, the contribution value of a controlled data may be generated by combining the contribution values of multiple real-time data that match the controlled data, that is, the contribution value of the controlled data may change as new real-time data is added. Specifically, in an embodiment, a process parameter Pn of the real-time data may have a contribution value Cn, and the process parameter Pn of the controlled data that matches the real-time data may have a controlled contribution value Dn, wherein the controlled data includes N real-time data (N is at least 1), or the contribution value of the controlled data is generated by combining the contribution values of N real-time data. In such condition, after the contribution value of the real-time data is incorporated into the contribution value of the controlled data, the controlled contribution value Dn of the process parameter Pn of the controlled data may be changed to (Cn+N*Dn)/(N+1). In short, the above-mentioned storage method of the real-time data is by incorporating the contribution values of the real-time data having the same causes and/or solutions of abnormality into the contribution value of a controlled data, that is, the controlled data is a collection of the real-time data that have the same causes and/or solutions of abnormality. It should be noted that when a controlled data has already formed by combining multiple real-time data, the above-mentioned filtering step is not needed before comparing the real-time data and the controlled data.

In another aspect, if all of the causes and/or solutions of the abnormality recorded in the controlled data output by the output unit 104 are not the causes and/or solutions of the abnormality of the real-time data, a step S107: making the real-time data as a new controlled data may be performed. In other words, the real-time data may serve as a new controlled data in the controlled database, and the controlled contribution value of the controlled data may be the contribution value of the real-time data. In addition, when the output unit 104 does not output any comparing result (for example, the comparing values generated by all controlled data are greater than 1), the real-time data may be considered not matching current controlled data in the controlled database. In such condition, the step S107 may also be performed to make the real-time data as a new controlled data.

In some embodiments, the real-time data may be incorporated into the controlled database in terms of abnormal events. That is, in the step of storing the real-time data in the controlled database, each real-time data may be regarded as an independent abnormal event. Specifically, in the step S104, regardless of whether the controlled data matching the real-time data is found, the step S107 may be performed to make the real-time data as a new controlled data. In other words, the real-time data received in each time may respectively serve as a new controlled data in the controlled database in subsequent process.

According to the present disclosure, by incorporating the real-time data into the controlled database through the above-mentioned ways, the accuracy of comparison between real-time data subsequently monitored and the controlled data may increase, thereby improving the performance of the process management system 100. It should be noted that the above-mentioned processing methods of the real-time data (or the storage methods of the real-time data in the controlled database) are exemplary, and the present disclosure is not limited thereto.

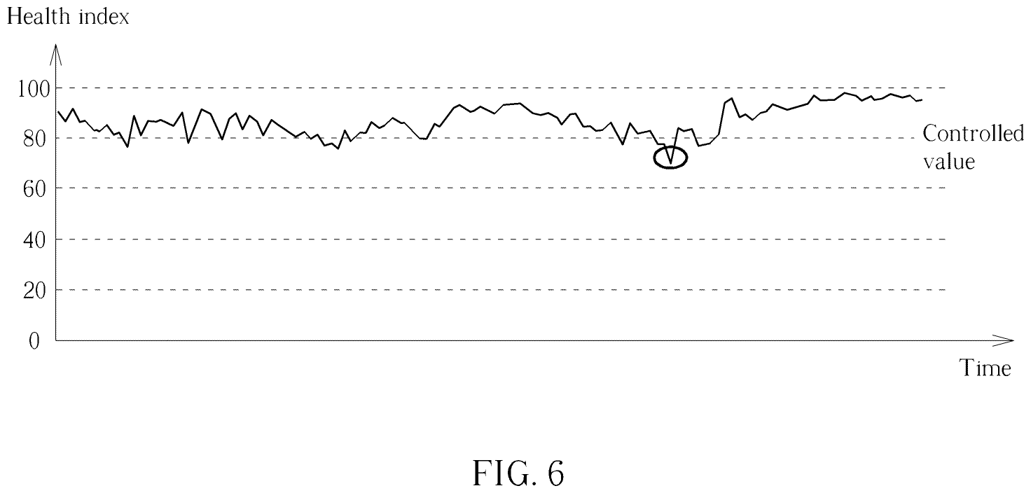

Referring to FIG. 6, FIG. 6 shows a schematic diagram of change of the health indicators of the process monitored by the process management system of the present disclosure over time. Specifically, FIG. 6 shows the health index at different time when the machine is operating. For example, each turning point on the polyline shown in FIG. 6 may represent a health index monitored during the manufacturing process of a sample. The health index may be obtained by integrating process parameters, wherein the health index may be used to monitor abnormal situations such as process parameters deviating from the normal range or correlation of process parameters deviating from the normal range. In some embodiments, the health index may be defined as the average value of the process parameters. In some embodiments, the health index may be defined as the value of the weighted average of the process parameters in different weights. It should be noted that the health index is not limited to be defined through all process parameters that can be monitored by the process management system 100. In some embodiments, the health index may be obtained through a portion of the process parameters that can be monitored by the process management system 100. In other words, the process management system 100 may monitor the process parameters of the machine and convert them into health index according to the above-mentioned method. Specifically, as shown in FIG. 6, according to the calculating method of the health index, a controlled value (for example 80 in FIG. 6, but not limited thereto) of the health index may be preset, and when the health index is less than the preset controlled value, it can be regarded that the monitored process parameters are deviated from the normal range or the correlation of the process parameters is deviated from the normal range. The controlled value of the health index may be determined according to the monitoring requirements of the process management system 100.

According to the present disclosure, by recording the process parameters or health index of the machine during the manufacturing process of the sample, when a sample is found to have quality abnormality in the subsequent testing step of the sample, the process parameters of the manufacturing process of the sample may be traced, and the process parameters of the sample may be stored in the controlled database as the controlled data. Therefore, the controlled database used for comparing with the real-time data may be built. In addition, in some embodiments, when a sample is found to be abnormal in the subsequent testing step, the controlled alarm mentioned above may be triggered, and the process parameters of the manufacturing process of the sample may serve as the real-time data and be transmitted to the receiving unit 101, such that the subsequent comparing step of the real-time data and the controlled data may be performed. In such condition, the controlled alarm may be triggered after the manufacturing process of the sample. In some embodiments, when the process management system 100 monitors that the health index of the manufacturing process of a sample is less than the controlled value (such as the sample circled in FIG. 6), the process management system 100 may automatically trigger a controlled alarm and transmit the process parameters of the sample to the receiving unit 101 as the real-time data to be compared with the controlled data. In such condition, the controlled alarm may be triggered during the manufacturing process of the sample. In other words, in the present disclosure, after monitoring the health index during the manufacturing processes of different samples through the process management system 100, the process parameters of a sample may be traced when abnormality of the sample is subsequently detected, such that the process parameters may be compared with the controlled data in the controlled database and stored in the controlled database as the controlled data (referring to the step S106 and the step S107 above). In addition, when the process management system 100 monitors that the health index of the manufacturing process of a sample is less than the controlled value, the process management system 100 may automatically transmit the process parameters of the sample to the receiving unit 101, and the comparing step and/or the step of storing the process parameters in the controlled database mentioned above may be performed.

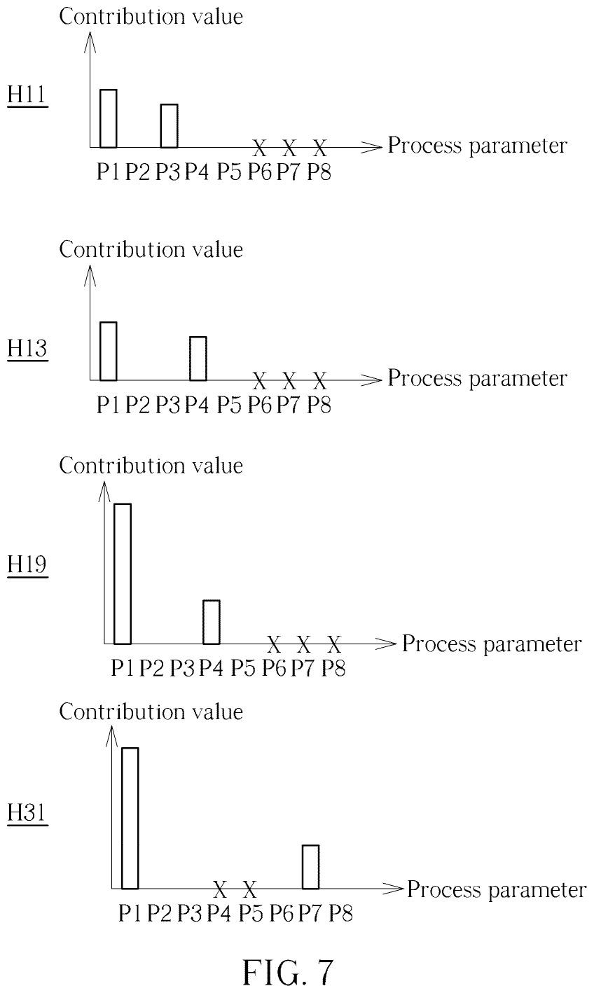

Referring to FIG. 7, FIG. 7 shows the comparing method of abnormal events of multiple samples under different monitoring models by the process management system of the present disclosure. Specifically, FIG. 7 and table 1 may be referred at the same time to illustrate the comparing method of abnormal events of multiple samples under different monitoring models of the process management system, wherein the label “*” shown in the table 1 represents that the real-time data is abnormal. In the present disclosure, the process management system 100 may monitor the real-time data of the machine through a monitoring model, wherein the monitoring model includes a selected group of process parameters. In other words, when it is described that the process management system 100 monitors the real-time data of the machine through a monitoring model, it may represent that the process management system 100 monitors a group of process parameters of the machine, and the monitoring model may be regarded as including the group of process parameters. In such condition, when the real-time data of the machine is monitored through a monitoring model, the monitored real-time data includes the process parameters included in the monitoring model. For example, the real-time data shown in FIG. 4 and FIG. 5 include the process parameter P1, the process parameter P2, the process parameter P3, the process parameter P4 and the process parameter P5, and therefore, the real-time data may be regarded as being monitored through a monitoring model including the process parameter P1, the process parameter P2, the process parameter P3, the process parameter P4 and the process parameter P5. Similarly, the controlled data shown in FIG. 4 and FIG. 5 may also be monitored through the monitoring model including the process parameter P1, the process parameter P2, the process parameter P3, the process parameter P4 and the process parameter P5. In other words, the real-time data and the controlled data shown in FIG. 4 and FIG. 5 may be regarded as being monitored through the same monitoring model.

The process management system 100 may monitor the real-time data of the machine through different monitoring models, wherein the types or numbers of the process parameters included in different monitoring models may not completely the same. In other words, “the process management system 100 monitors the real-time data of the machine through different monitoring models” mentioned above may include the condition that the process management system 100 monitors different groups of process parameters of the machine. In such condition, the real-time data of the machine monitored through different monitoring models may include different types or numbers of process parameters. For example, table 1 shows the numbers of the real-time data obtained by monitoring samples S1 to S9 through monitoring model M1 to monitoring model M5 respectively. In detail, the real-time data obtained by monitoring the sample S1 through the monitoring model M2 may be called the real-time data H21; the real-time data obtained by monitoring the sample S3 through the monitoring model M4 may be called the real-time data H43. The numbers of other real-time data may be described in the above-mentioned way, and will not be redundantly described. Referring to FIG. 7, the monitoring model M1 may include the process parameter P1, the process parameter P2, the process parameter P3, the process parameter P4 and the process parameter P5 (in FIG. 7, the label “X” indicates that the process parameter is not monitored in the monitoring model), and the monitoring model M3 may include the process parameter P1, the process parameter P2, the process parameter P3, the process parameter P6, the process parameter P7 and the process parameter P8. The types or numbers of process parameters included in other monitoring models are not shown in FIG. 7 and are not completely the same as the types or numbers of process parameters included in the monitoring model M1 and the monitoring model M3.

TABLE 1
the numbers of the real-time data of the samples
corresponding to the monitoring models

| | S1 | S2 | S3 | S4 | S5 | S6 | S7 | S8 | S9 |
|---|---|---|---|---|---|---|---|---|---|
| M1 | H11(*) | H12 | H13(*) | H14 | H15 | H16 | H17 | H18 | H19(*) |
| M2 | H21 | H22 | H23 | H24 | H25 | H26 | H27 | H28 | H29 |
| M3 | H31(*) | H32 | H33 | H34 | H35 | H36 | H37 | H38 | H39 |
| M4 | H41 | H42 | H43 | H44 | H45 | H46 | H47 | H48 | H49 |
| M5 | H51 | H52 | H53 | H54 | H55 | H56 | H57 | H58 | H59 |

In an embodiment, as shown in table 1 and FIG. 7, an abnormal event is detected when the sample S1 is monitored through the monitoring model M1, that is, the real-time data H11 is abnormal; an abnormal event is detected when the sample S1 is monitored through the monitoring model M3, that is, the real-time data H31 is abnormal; an abnormal event is detected when the sample S3 is monitored through the monitoring model M1, that is, the real-time data H13 is abnormal. In such condition, the controlled alarm mentioned above may be triggered, and the real-time data H11, the real-time data H31 and the real-time data H13 may be processed in the above-mentioned ways through the receiving unit 101, the calculating unit 102 and the comparing unit 103, and then the controlled data may be created according to the real-time data H11, the real-time data H31 and the real-time data H13. FIG. 7 for example shows the contribution value of the real-time data H11, the contribution value of the real-time data H13 and the contribution value of the real-time data H31. After the real-time data H11, the real-time data H13 and the real-time data H31 are respectively stored as the controlled data, the contribution values of the real-time data H11, the real-time data H13 and the real-time data H31 may respectively be the controlled contribution values of the controlled data. After that, when an abnormal event is detected when the sample S9 is monitored through the monitoring model M1, that is, the real-time data H19 is abnormal, a controlled alarm may be triggered, such that the contribution value of the real-time data H19 may be calculated (as shown in FIG. 7) and compared with the created controlled data mentioned above to generate a comparing value.

In some embodiments, the contribution value of the real-time data monitored through a monitoring model may only be compared with the controlled contribution value of the controlled data transformed from the real-time data monitored through the monitoring model. Specifically, when a real-time data is obtained under the monitoring model M1, in the step of comparing the real-time data with the controlled data through the comparing unit 103, the real-time data may only be compared with the controlled data transformed from the real-time data monitored through the monitoring model M1. For example, referring to table 1 and FIG. 7, in this comparing way, the contribution value of the real-time data H19 may be compared with the contribution value of the real-time data H11 and the contribution value of the real-time data H13, but not compared with the contribution value of the real-time data H31. Therefore, since the comparing value generated by comparing the real-time data H19 with the real-time data H13 is smaller, or the real-time data H19 and the real-time data H13 are more matching, the real-time data H19 may be determined to have the same causes of abnormality as the real-time data H13, wherein the causes of abnormality may be the process parameter P1 and the process parameter P4 deviating from the normal range.

In some embodiments, the contribution value of the real-time data monitored through a monitoring model is not limited to be compared only with the controlled contribution value of the controlled data transformed from the real-time data monitored through the monitoring model, which may further be compared with the controlled contribution value of the controlled data transformed from the real-time data monitored through other monitoring models. Specifically, in this comparing way, the contribution value of the real-time data H19 may further be compared with the contribution value of the real-time data H31. It should be noted that when the real-time data and controlled data used for comparison are monitored through different monitoring models, all process parameters with contribution values not equal to 0 in the controlled data may be considered when calculating the comparing value. For example, when comparing the real-time data H19 and the real-time data H31 to generate the comparing value, the sub-comparing values of the process parameter P1 and the process parameter P7 may respectively be calculated (the calculating method thereof may refer to the contents mentioned above), thereby obtaining the comparing value. Since the real-time data H19 does not include the process parameter P7 (that is, the monitoring model M1 does not include the process parameter P7), the process parameter P7 of the real-time data H19 may be regarded as 0 when calculating the sub-comparing value of the process parameter P7. The comparing method (or the calculating method of comparing value) mentioned above may be applied to the embodiments and variant embodiments of the present disclosure. According to this comparing method, the comparing value generated by comparing the real-time data H19 with the real-time data H31 may be less than the comparing value generated by comparing the real-time data H19 with the real-time data H13 (since the contribution value of the process parameter P1 of the real-time data H19 is closer to the contribution value of the process parameter P1 of the real-time data H31 and is much greater than the contribution value of the process parameter P1 of the real-time data H13). In such condition, the real-time data H19 may be determined to have the same causes of abnormality as the real-time data H31, wherein the causes of abnormality may be the process parameter P1 significantly deviating from the normal range, and the deviation of the process parameter P4 of the real-time data H19 and the deviation of the process parameter P7 of the real-time data H31 are not the main cause of the abnormal event.

In summary, a process management system is provided by the present disclosure. The process management system includes a receiving unit, a calculating unit, a comparing unit and an output unit. The receiving unit may be used for receiving a real-time data when a controlled alarm is triggered, the calculating unit may be used for generating the contribution value of the real-time data, the comparing unit may be used for comparing the contribution value of the real-time data and the controlled contribution value of the controlled data in the controlled database to generate a comparing value, and the output unit may output the corresponding comparing result according to the comparing value. In other words, the process management system of the present disclosure may detect abnormal events of the machine and analyze the abnormal events based on the data previously collected to provide the user with possible causes and/or solutions of the abnormal events. Therefore, the efficiency of handling abnormal events may be improved, thereby reducing losses caused by machine abnormalities or sample abnormalities. In other words, the user may record the causes and solutions of abnormal events, and related data such as process parameters of the machine may be stored through the process management system when the abnormal events occur. When a new abnormal event occurs, the process management system may find the historical abnormal event which is the most similar to the new abnormal event through the historical data (such as the process parameter of historical abnormal events), and the causes and solutions of the historical abnormal event may be provided to the user or the process personnel as reference.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A process management system, comprising:
a receiving unit used for receiving a real-time data of a machine, wherein the real-time data comprises at least one parameter value;
a calculating unit used for calculating and generating at least one contribution value of the real-time data, wherein the at least one contribution value is calculated from the at least one parameter value;
a comparing unit used for comparing the at least one contribution value and at least one controlled contribution value of at least one controlled data to generate at least one comparing value; and
an output unit used for outputting at least one comparing result to which the at least one comparing value corresponds.

2. The process management system of claim 1, wherein the real-time data comprises at least one process parameter of the machine, and the at least one parameter value is a value of the at least one process parameter.

3. The process management system of claim 2, wherein the at least one process parameter comprises temperature, air flow rate or pressure.

4. The process management system of claim 1, wherein the at least one controlled contribution value of the at least one controlled data is calculated according to a default data string, wherein the default data string comprises a plurality of default data, and each of the plurality of default data comprises at least one default parameter value.

5. The process management system of claim 4, wherein the at least one parameter value of the real-time data comprises a parameter value Vn, the at least one contribution value of the real-time data comprises a contribution value Cn calculated from the parameter value Vn, a plurality of the default parameter values of the plurality of default data of the default data string corresponding to the parameter value Vn has an average value An, and the parameter value Vn, the contribution value Cn and the average value An satisfy:
$$Cn = Vn - An .$$

6. The process management system of claim 4, wherein the at least one parameter value of the real-time data comprises a parameter value Vn, the at least one contribution value of the real-time data comprises a contribution value Cn calculated from the parameter value Vn, a plurality of the default parameter values of the plurality of default data of the default data string corresponding to the parameter value Vn has an average value An and a standard deviation Sn, and the parameter value Vn, the contribution value Cn, the average value An and the standard deviation Sn satisfy:
$$Cn = ( Vn - An ) / Sn .$$

7. The process management system of claim 1, wherein the process management system is coupled to a display unit, and the at least one comparing result is displayed through the display unit.

8. The process management system of claim 1, wherein the real-time data is stored in a cloud system.

9. The process management system of claim 1, wherein the at least one controlled contribution value of the at least one controlled data is obtained when the machine is failed and/or abnormal.

10. The process management system of claim 1, wherein the at least one comparing value comprises a plurality of comparing values, the at least one comparing result comprises a plurality of comparing results, the plurality of comparing values respectively correspond to the plurality of comparing results, and when any one of the plurality of comparing values is less than 1, the output unit outputs the comparing result to which the any one comparing value corresponds.

11. The process management system of claim 1, wherein the receiving unit receives the real-time data of the machine when a controlled alarm is triggered.

12. The process management system of claim 11, wherein the controlled alarm is triggered when the machine is abnormal and/or a sample manufactured by the machine is abnormal.

13. The process management system of claim 1, wherein the at least one comparing result comprises a cause and/or a solution of the at least one controlled data.

14. An operating method of a process management system, comprising:
receiving a real-time data through a receiving unit of the process management system, wherein the real-time data comprises at least one parameter value;
calculating at least one contribution value of the real-time data through a calculating unit of the process management system, wherein the at least one contribution value is calculated from the at least one parameter value;
comparing the at least one contribution value and at least one controlled contribution value of at least one controlled data to generate at least one comparing value through a comparing unit of the process management system; and
outputting at least one comparing result to which the at least one comparing value corresponds through an output unit of the process management system.

15. The operating method of claim 14, wherein the at least one controlled contribution value of the at least one controlled data is calculated according to a default data string, wherein the default data string comprises a plurality of default data, and each of the plurality of default data comprises at least one default parameter value.

16. The operating method of claim 15, wherein the at least one parameter value of the real-time data comprises a parameter value Vn, the at least one contribution value of the real-time data comprises a contribution value Cn calculated from the parameter value Vn, a plurality of the default parameter values of the plurality of default data of the default data string corresponding to the parameter value Vn has an average value An, and the parameter value Vn, the contribution value Cn and the average value An satisfy:
$$Cn = Vn - An .$$

17. The operating method of claim 15, wherein the at least one parameter value of the real-time data comprises a parameter value Vn, the at least one contribution value of the real-time data comprises a contribution value Cn calculated from the parameter value Vn, a plurality of the default parameter values of the plurality of default data of the default data string corresponding to the parameter value Vn has an average value An and a standard deviation Sn, and the parameter value Vn, the contribution value Cn, the average value An and the standard deviation Sn satisfy:
$$Cn = ( Vn - An ) / Sn .$$

18. The operating method of claim 17, wherein when the contribution value Cn calculated from the parameter value Vn is located in a range from −3 to 3, change the contribution value Cn to 0.

19. The operating method of claim 14, wherein the at least one comparing value comprises a plurality of comparing values, the at least one comparing result comprises a plurality of comparing results, the plurality of comparing values respectively correspond to the plurality of comparing results, and when any one of the plurality of comparing values is less than 1, the output unit outputs the comparing result to which the any one comparing value corresponds.

20. The operating method of claim 14, wherein the at least one controlled data is stored in a controlled database, and the operating method of the process management system further comprises incorporating the real-time data into the controlled database after outputting the at least one comparing result through the output unit.
